(19) United States
(12) Patent Application Publication
(10) Pub. No.: US 2025/0100446 A1
(43) Pub. Date: Mar. 27, 2025

(54) Panable Camera with Trailer Length and Object Detection for Mirrorless Vehicles

(71) Applicant: Bendix Commercial Vehicle Systems LLC, Avon, OH (US)

(72) Inventors: Thomas J. Hayes, Lakewood, OH (US); William R. Plow, Avon, OH (US)

(73) Assignee: Bendix Commercial Vehicle Systems LLC, Avon, OH (US)

(21) Appl. No.: 18/373,390

(22) Filed: Sep. 27, 2023

(51) Int. Cl. B60Q 9/00; B60R 1/25; H04N 23/695

(52) U.S. Cl. CPC B60Q 9/00; B60R 1/25; H04N 23/695; B60R 2300/8093

(57) ABSTRACT

Embodiments are presented herein for a panable camera with trailer length and object detection for vehicles equipped with cameras to supplement or replace mirrors commonly used today. In one embodiment, a vehicle controller is provided comprising: one or more processors; a non-transitory computer-readable medium; and program instructions stored on the non-transitory computer-readable medium. The program instructions, when executed by the one or more processors, cause the one or more processors to: cause a side-view camera on a tractor to capture image(s) of leading, lower, upper and/or trailing edges of a trailer coupled with the tractor; and estimate a length of the trailer based on the image(s) captured by the side-view camera. Other embodiments are provided.

### BACKGROUND

Some heavy-duty commercial vehicles configured for towing a trailer can be equipped with one or more cameras. For example, a camera can be used as a supplement or replacement for front and/or side mirrors to allow a driver to see the side of the vehicle.

### BRIEF DESCRIPTION OF THE DRAWINGS

FIG. 1 is a block diagram of components of a vehicle of an embodiment.

FIG. 2 is a flow chart of a method of an embodiment for trailer length and object detection.

FIG. 3 is an illustration of a display screen of an embodiment displaying an image from a side-view camera.

### SUMMARY

The following embodiments generally relate to vehicles equipped with cameras to supplement or replace mirrors commonly used today. In one embodiment, a vehicle controller is provided comprising: one or more processors; a non-transitory computer-readable medium; and program instructions stored on the non-transitory computer-readable medium. The program instructions, when executed by the one or more processors, cause the one or more processors to: cause a side-view camera on a tractor to capture image(s) of leading, lower, upper and/or trailing edges of a trailer coupled with the tractor; and estimate a length of the trailer based on the image(s) captured by the side-view camera.

In another embodiment, a method is provided that is performed in a vehicle comprising a tractor, a trailer towed by the tractor, and at least one image capture device. The method comprises: capturing image(s) of the trailer using the at least one image capture device; and analyzing the image(s) of the trailer to estimate a length of the trailer.

In yet another embodiment, a tractor is provided comprising: at least one image capture device; and means for estimating a length of a trailer towed by the tractor based on images of leading, lower, upper and/or trailing edges of the trailer that are captured by the at least one image capture device.

Other embodiments are possible, and each of the embodiments can be used alone or together in combination.

### DETAILED DESCRIPTION

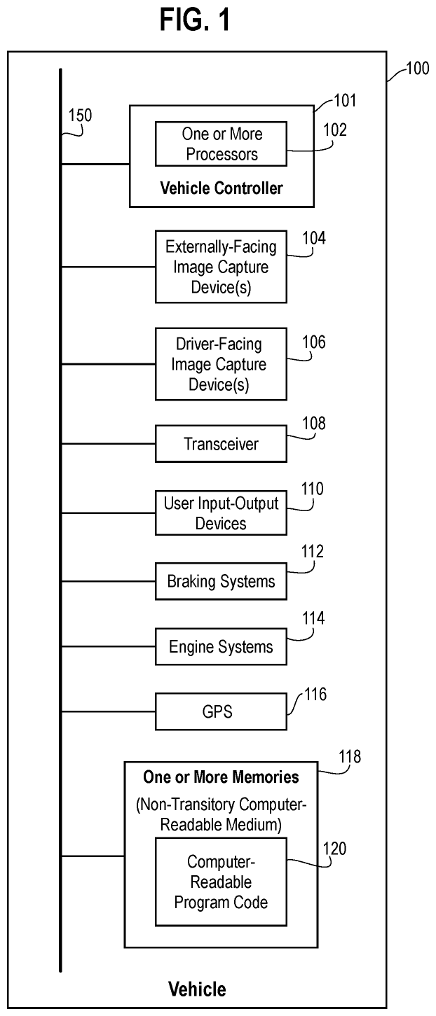

Turning now to the drawings, FIG. 1 is a block diagram of example components of a vehicle 100 of an embodiment. In one embodiment, the vehicle 100 is an on/off road vehicle as described by NHTSA Title 49, Subtitle B, Chapter V, Part 571, Subpart A, Section 571.3, where the vehicle can be one or more of the following in sensible combinations: “Truck”, “Truck tractor”, “Trailer”, “Full trailer”, “Trailer converter dolly”, “Semitrailer”, and/or “Pole trailer.” A “cab” will sometimes be referred to herein where a cab is the portion of a tractor where the vehicle operator typically controls the vehicle. Further details of the typical or required inputs and outputs provided to a vehicle operator are not the subject of this patent.

As shown in FIG. 1, the vehicle 100 in this example comprises one or more of the following: a vehicle controller 101 comprising one or more processors 102, externally-facing image capture device(s) (e.g., camera(s)) 104, driver-facing image capture device(s) 106, a transceiver 108, user input-output (IO) devices 110 (e.g., a microphone, a speaker, a touchscreen, indicator lights, etc.), a braking system 112, an engine system 114, a global positioning system (GPS) 116 that can identify a location of the vehicle, and one or more memories 118. An image capture device can be any device capable of digitizing an image (e.g., camera, LIDAR, radar, ultrasound, etc., or any combination thereof). In one embodiment, the externally-facing image capture device 104 is a replacement/supplement to a front mirror and/or side mirror(s). Also, the vehicle 100 can have other devices, including, but not limited to, forward-facing cameras, radars, lidars, and environmental sensors.

These various components can be in communication with each other directly or indirectly (through components that may or may not be shown or described herein) via wired (e.g., controller area network (CAN), ethernet, automotive ethernet, power line communication (PLC), etc.) or wireless (e.g., WiFi, Bluetooth, cellular, etc.) connections. In the example in FIG. 1, the components are directly or indirectly connected via a bus 150, which can take the form of a controller area network (CAN).

The one or more memories 118 (e.g., one or more non-transitory computer-readable medium) store computer-readable program code 120. These one or more memories 118 can be the same type or different types and can be part of the same memory device or be different memory devices. For example, some or all of the memories in the one or more memories 118 can be volatile or non-volatile non-transitory memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof.

The one or more processors 102 can execute the computer-readable program code 120, which can have instructions (e.g., modules, routines, sub-routine, programs, applications, etc.) that, when executed by the one or more processors 102, cause the one or more processors 102 to perform certain functions, such as those discussed herein, as well as other functions not described herein. It should be noted that the one or more processors 102 can have different functions (e.g., a first subset of one or more processors can be used for certain functions, while a second subset of one or more processors can be used for other certain functions). The one or more processors 102 can also take the form of a purely-hardware implementation (e.g., an application-specific integrated circuit (ASIC)).

As mentioned above, some heavy-duty commercial vehicles configured for towing a trailer can be equipped with one or more cameras. For example, the externally-facing camera(s) 104 can be used as a replacement for side mirror(s) to allow a driver to see the side(s) of the vehicle or can augment a side mirror. The following embodiments take advantage of this technological shift away from traditional mirrors to camera-based systems to provided additional functions not previously possible. Such functions can include trailer length and object detection, as discussed below.

Currently, it is difficult for a driver to gauge the length of a trailer when the driver is in the cab using only traditional, mechanical side mirrors. Also, it can be difficult for a driver to adjust mechanical mirrors when the driver is inside the cab. So, it can be difficult for a driver to maintain an optimal view if the vehicle configuration changes by adding or removing trailers. In addition, a traditional mirror does not allow for any kind of additional details to be displayed on its surface to inform the driver of possible events of importance.

The following embodiments leverage the use of cameras as side-view mirrors, which can be on a sturdy and fixed point on the side of the cab. In one embodiment, the side mirror has two different modes of operation to gauge the length of trailers depending on the technology used in the camera system. For example, if the camera has a wide viewing angle, the camera can pan digitally to show only the area of interest to the driver inside the cab (e.g., on screens mounted on the A pillar). However, if the camera does not have a wide viewing angle, it can pan mechanically to the same point of interest, displaying this area to the driver inside the cab. In a two-camera system (e.g., one on the driver side and one on the passenger side), as the cameras pan, they know their position on the side of the truck and will be able to determine the angle of their pan once they view the trailing edge of a trailer.

The processor(s) 102 can then use a trigonometry calculation to determine the length of the trailer in view. The processor(s) 102 can repeat this task if there are multiple trailers towed, each time stopping to record the length of the observed trailer. Once all the trailers are accounted for, the cameras can position themselves in a position (e.g., the ideal position) to maintain as much road view as possible, adjusting to the change of the vehicle system, as needed.

In one embodiment, upon key-on or upon a detected change in the vehicle system indicating the addition or removal of a trailer, the side mirror cameras can begin to pan from their at-rest positions until a first trailing edge is detected. The processor(s) 102 can calculate the length of one trailer and then move onto calculating the length of a second trailer, if present. Once all of the trailers are measured, the cameras can position themselves (e.g., as commanded by the processor(s) 102) to a certain viewing angle (e.g., an ideal viewing angle) and monitor this area, communicating pertinent information to the driver.

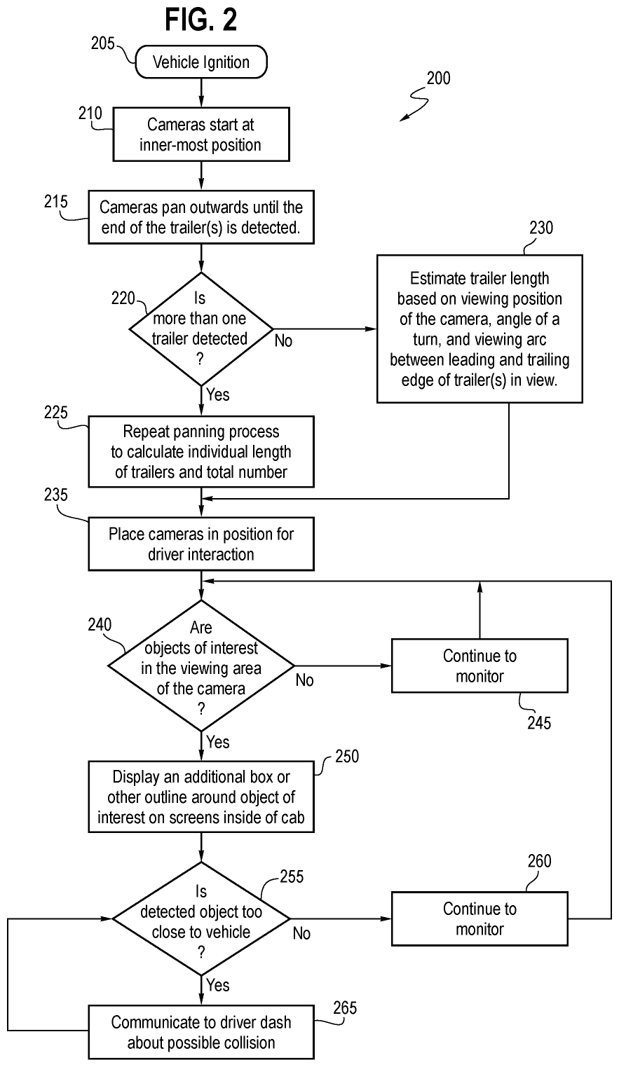

FIG. 2 is a flow chart 200 of a method of an embodiment for trailer length and object detection. As shown in FIG. 2, after vehicle ignition (act 205), the cameras (e.g., one camera as the driver-side mirror and the other as the passenger-side mirror) on the vehicle start at their initial (e.g., inner-most) position (act 210). Then, the cameras pan outwards until the end of the trailer(s) is detected (act 215) (the panning can be mechanical or digital with a high-resolution camera). Image processing by the processor(s) 102 can identify key characteristics that can include, but are not limited to, leading vertical edge of the trailer, trailing vertical edge of the trailer, lower horizontal edge of the trailer marked with reflective tape, lower horizontal edge of the trailer marked with “scaled” reflective tape, lower horizontal edge of the trailer without reflective tape, optical character recognition (OCR) of trailer dimensions marked in predetermined location of the trailer (e.g., at the front and/or side of the trailer), a quick response (QR) or bar code describing trailer dimensions, and/or a QR or bar code identifying the trailer in a database.

Next, the processor(s) 102 can determine if more than one trailer is detected (act 220). If more than one trailer is detected, the panning process is repeated to calculate the individual length of the trailer and the total number of trailers (act 225). If more than one trailer is not detected, the processor(s) 102 can estimate the trailer length based on a viewing position of the camera, the angle of a turn, and the viewing arc between the leading and trailing edges of the trailer(s) in view (act 230). The angle of the turn can be determined by configuration and sensor inputs, which can include, but are not limited to, steer angle sensor, wheel speeds, slope of the vehicle, wheel base, and/or wheel track.

Next, the cameras are placed in a position (e.g., an optimal position) for driver interaction (act 235). The processor(s) 102 can then determine if an object of interest (e.g., people, cars, motorcycles, debris, etc.) is in the viewing angle of the camera (act 240). Object size, position, and relative velocities can be scaled in relation to trailer size, position, and velocity. If objects of interest are not in the viewing angle of the camera, the processor(s) 102 continue monitoring the viewing angle of the camera (act 245). However, if an object of interest is in the viewing angle of the camera, the processor(s) 102 can display an additional box, outline, or other indicia around or near the object of interest on the screen(s) inside the cab of the vehicle (act 250).

The processor(s) 102 can then determine if the object is detected to be too close to the vehicle (e.g., within a certain threshold distance) (act 255). If the processor(s) 102 determine that the object is not too close to the vehicle, the processor(s) 102 can continue the monitoring process (act 260). However, if the processor(s) determine that the object is too close to the vehicle, the processor(s) 102 can communicate to the driver dash about a possible collision (act 265).

The following is an example of a method to measure a trailer length with a single camera. It should be noted that this is merely one example and that other implementations can be used. Also, while this example is illustrated in terms of a single camera, other methods can use more than one camera.

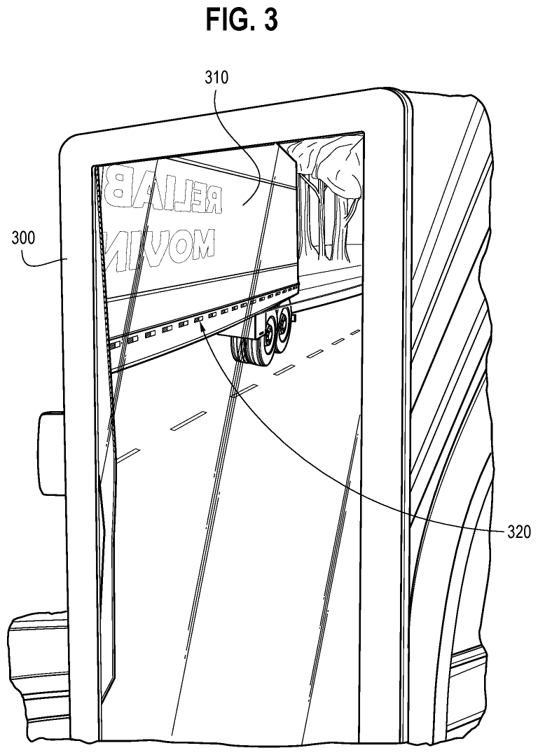

This example method will be discussed in conjunction with FIG. 3, which shows a display screen 300 that is displaying the output of a driver-side camera. The display screen 300 is inside the cab of the vehicle, and the displayed output shows the trailer 310 of the vehicle. The lower edge of the trailer 310 is marked with reflective tape 320 (e.g., DOT C2 reflective tape that alternates white and red and looks silvery in the daytime), which is commonly used for trailer classification for commercial vehicles exceeding 10,000 pounds and over 80 inches wide. (The DOT C2 tape has a standard height of two inches, and that standard height can be used to establish the length of the trailer, which would not be the case if the tape had an unknown, non-standard height.)

The processor(s) 102 can analyze the displayed image for the height in pixels of the reflective tape 320 at the nearest point and furthest points in the image. In this example, there is a transition ratio of two inches as the image is processed along the lower edge of the trailer 310. In a first pass, the total number of pixels from the beginning of the trailer edge in view to the end of the trailer edge in view are counted and recorded as a critical pixel for the lower trailer edge measurement. A pixel ratio factor can be determined by the following equation:

$$Pixel\_Ratio \_Factor = \frac{\# of pixels for 2 \text{''} height at front of trailer}{\# of pixels for 2 \text{''} height at rear of trailer} \div total \#of pixels on lower edge of trailer$$

The distance between two pixels at the nearest edge (front) of the trailer 310 can be calculated and recorded by the following equation:

$${pixel}_{front} = 2 \text{''} \div \#of pixels for height at rear of trailer$$

In a second pass, the processor(s) 102 can process the image by counting the critical pixels identified as the lower trailer edge from the beginning of the trailer edge in view to the end of the trailer edge in view. The distance between each pair of two pixels can be calculated and totaled as shown in the following equation:

$$Trailer Length = {\sum }_{x = 0}^{pixels - 1} {pixel}_{front} + x \cdot Pixel\_Ratio \_Factor$$

It should be noted that this method assumes that the image is captured with sufficient detail (e.g., number of pixels) to produce a result without significant error. Lower resolution images may require that more pixels be inserted/interpreted. Alternatively, multi-pixel steps can be used instead of single-pixel steps. Further, this method demonstrates only one example technique for a single camera to analyze an image of a trailer and determine its length using image analysis. As noted above, other techniques can be used. Additionally, the estimated length can be utilized with parameters of the brake controller. Also, the calculated length of the trailer can be adjusted to account for the pivot point of the trailer image as this can represent the kingpin location on the trailer. The determined length can be considered as the length from the position of the tractor-trailer fifth wheel connection.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A vehicle controller comprising:
one or more processors;
a non-transitory computer-readable medium; and
program instructions stored on the non-transitory computer-readable medium that, when executed by the one or more processors, cause the one or more processors to:
cause a side-view camera on a tractor to capture image(s) of leading, lower, upper and/or trailing edges of a trailer coupled with the tractor; and
estimate a length of the trailer based on the image(s) captured by the side-view camera.

2. The vehicle controller of claim 1, wherein the program instructions, when executed by the one or more processors, further cause the one or more processors to:
detect an object of interest captured by the side-view camera; and
display, on a display device, indicia near a display of the object of interest.

3. The vehicle controller of claim 2, wherein the program instructions, when executed by the one or more processors, further cause the one or more processors to:
determine whether the object of interest is within a threshold distance of the vehicle; and
in response to determining that the object of interest is within the threshold distance of the vehicle, generate a driver alert.

4. The vehicle controller of claim 1, wherein the length of the trailer is estimated based on a viewing position of the side-view camera, an angle of a turn, and/or a viewing arc between the leading and trailing edges of the trailer.

5. The vehicle controller of claim 4, wherein the angle of the turn is determined from an output of a steer-angle sensor, an output of a wheel-speed sensor, a slope of the vehicle, an identification of a wheel base, and/or an identification of a wheel track.

6. The vehicle controller of claim 1, wherein:
the vehicle comprises at least one additional trailer coupled with the tractor; and
the program instructions, when executed by the one or more processors, further cause the one or more processors to:
cause the side-view camera on the tractor to capture image(s) of leading and trailing edges of the at least one additional trailer; and
estimate length(s) of the at least one additional trailer based on the image(s) of the at least one additional trailer captured by the side-view camera.

7. The vehicle controller of claim 1, wherein the side-view camera is configured to pan mechanically to capture the image(s) of the leading and trailing edges of the trailer.

8. The vehicle controller of claim 1, wherein the side-view camera is configured to digitally pan to capture the image(s) of the leading and trailing edges of the trailer.

9. The vehicle controller of claim 1, wherein the program instructions, when executed by the one or more processors, further cause the one or more processors to:
cause a second side-view camera on the tractor to capture image(s) of leading and trailing edges of the trailer; and
estimate the length of the trailer based on the image(s) captured by the second side-view camera.

10. A method comprising:
performing in a vehicle comprising a tractor, a trailer towed by the tractor, and at least one image capture device:
capturing image(s) of the trailer using the at least one image capture device; and
analyzing the image(s) of the trailer to estimate a length of the trailer.

11. The method of claim 10, further comprising:
displaying, on a display device, indicia near a display of a detected object of interest.

12. The method of claim 11, further comprising:
generating an alert in response to the object of interest being within a threshold distance of the tractor or trailer.

13. The method of claim 12, wherein the length of the trailer is estimated based on an identification of a leading vertical edge of the trailer, an identification of a trailing vertical edge of the trailer, an identification of a lower horizontal edge of the trailer marked with reflective tape, an identification of a lower horizontal edge of the trailer marked with scaled reflective tape, and/or an identification of a lower horizontal edge of the trailer without reflective tape,

14. The method of claim 12, wherein the length of the trailer length is estimated based on indicia on the trailer displaying the length of the trailer, a quick response (QR) or bar code specifying the length of the trailer, and/or a QR or bar code identifying the trailer in a database that specifies the length of the trailer.

15. The method of claim 12, wherein the length of the trailer is estimated based on a height in pixels of reflective tape on the trailer at nearest and furthest points in the images.

16. The method of claim 12, wherein the image capture device comprises a side-view camera.

17. The method of claim 17, wherein the side-view camera is positioned on a driver-side of the vehicle, and wherein the vehicle comprises an additional side-view camera positioned on a passenger-side of the vehicle.

18. A tractor comprising:
at least one image capture device; and
means for estimating a length of a trailer towed by the tractor based on images of leading and trailing edges of the trailer that are captured by the at least one image capture device.

19. The tractor of claim 18, further comprising:
means for displaying, on a display device, indicia near a display of a detected object of interest.

20. The tractor of claim 19, further comprising:
means for generating an alert in response to the object of interest being within a threshold distance of the tractor or trailer.
